(19) United States
(12) Patent Application Publication
(10) Pub. No.: US 2024/0385884 A1
(43) Pub. Date: Nov. 21, 2024

(54) METHODS, SYSTEMS, ARTICLES OF MANUFACTURE AND APPARATUS TO ESTIMATE WORKLOAD COMPLEXITY

(71) Applicant: Intel Corporation, Santa Clara, CA (US)

(72) Inventors: Karthik Kumar, Chandler, AZ (US); Timothy Verrall, Pleasant Hill, CA (US); Thomas Willhalm, Sandhausen (DE); Francesc Guim Bernat, Barcelona (ES); Zhongyan Lu, Beijing (CN)

(21) Appl. No.: 18/571,092

(22) PCT Filed: Dec. 23, 2021
(86) PCT No.: PCT/CN2021/140690

§ 371 Date: Dec. 15, 2023

(51) Int. Cl. G06F 9/50

(52) U.S. Cl. CPC G06F 9/5027; G06F 2209/5019; G06F 2209/509

(57) ABSTRACT

Methods, apparatus, systems, and articles of manufacture are disclosed to estimate workload complexity. An example apparatus includes processor circuitry to perform at least one of first, second, or third operations to instantiate payload interface circuitry to extract workload objective information and service level agreement (SLA) criteria corresponding to a workload, and acceleration circuitry to select a pre-processing model based on (a) the workload objective information and (b) feedback corresponding to workload performance metrics of at least one prior workload execution iteration, execute the pre-processing model to calculate a complexity metric corresponding to the workload, and select candidate resources based on the complexity metric.

### FIELD OF THE DISCLOSURE

This disclosure relates generally to edge networks and, more particularly, to methods, systems, articles of manufacture and apparatus to estimate workload complexity.

### BACKGROUND

In recent years, network resources have become more available and include different resource capabilities. Such network resources are able to accept workloads in view of different types of tasks in a distributed manner. Increasingly, different types of workloads are targeting heterogenous network resources for task execution.

### BRIEF DESCRIPTION OF THE DRAWINGS

FIG. A1 illustrates an overview of an Edge cloud configuration for Edge computing.

FIG. A2 illustrates operational layers among endpoints, an Edge cloud, and cloud computing environments.

FIG. A3 illustrates an example approach for networking and services in an Edge computing system.

FIG. D2 is a schematic diagram of an example infrastructure processing unit (IPU).

FIG. 1 is a schematic illustration of an example workload analysis system to estimate workload complexity and assign workloads to available resources.

FIGS. 2-5 are flowcharts representative of example machine readable instructions and/or example operations that may be executed by example processor circuitry to implement the workload management circuitry of FIG. 1.

FIG. 6 is a block diagram of an example processing platform including processor circuitry structured to execute the example machine readable instructions and/or the example operations of FIGS. 2-5 to implement the example workload management circuitry of FIG. 1.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIGS. 2-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

FIG. A1 is a block diagram A100 showing an overview of a configuration for Edge computing, which includes a layer of processing referred to in many of the following examples as an “Edge cloud.” As shown, the Edge cloud A110 is co-located at an Edge location, such as an access point or base station A140, a local processing hub A150, or a central office A120, and thus may include multiple entities, devices, and equipment instances. The Edge cloud A110 is located much closer to the endpoint (consumer and producer) data sources A160 (e.g., autonomous vehicles A161, user equipment A162, business and industrial equipment A163, video capture devices A164, drones A165, smart cities and building devices A166, sensors and IoT devices A167, etc.) than the cloud data center A130. Compute, memory, and storage resources, which are offered at the edges in the Edge cloud A110, are critical to providing ultra-low latency response times for services and functions used by the endpoint data sources A160 as well as reducing network backhaul traffic from the Edge cloud A110 toward cloud data center A130, thereby improving energy consumption and overall network usages among other benefits.

Compute, memory, and storage are scarce resources and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is constrained. Thus, Edge computing attempts to reduce the amount of resources needed for network services through the distribution of more resources that are located closer both geographically and in network access time. In this manner, Edge computing attempts to bring the compute resources to workload data where appropriate, or bring the workload data to the compute resources. In some examples, a workload includes, but is not limited to, executable processes, such as algorithms, machine learning algorithms, image recognition algorithms, gain/loss algorithms, etc.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge,” “close Edge,” “local Edge,” “middle Edge,” or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices that are much closer to endpoint devices producing and consuming the data. For example, Edge gateway servers may be equipped with pools of memory and storage resources to perform computation in real-time for low latency use-cases (e.g., autonomous driving or video surveillance) for connected client devices. In another example, base stations may be augmented with compute and acceleration resources to directly process service workloads for connected user equipment without further communicating data via backhaul networks. In another example, central office network management hardware may be replaced with standardized compute hardware that performs virtualized network functions and offers compute resources for the execution of services and consumer functions for connected devices. Within Edge computing networks, there may be scenarios in services that the compute resource is “moved” to the data, as well as scenarios in which the data is “moved” to the compute resource. In another example, base station compute, acceleration and network resources can provide services to scale to workload demands on an as needed basis by activating dormant capacity (subscription, capacity on demand) to manage corner cases, emergencies or to provide longevity for deployed resources over a significantly longer implemented lifecycle.

FIG. A2 illustrates operational layers among endpoints, an Edge cloud, and cloud computing environments. Specifically, FIG. A2 depicts examples of computational use cases A205, utilizing the Edge cloud A110 among multiple illustrative layers of network computing. The layers begin at an endpoint (devices and things) layer A200, which accesses the Edge cloud A110 to conduct data creation, analysis, and data consumption activities. The Edge cloud A110 may span multiple network layers, such as an Edge devices layer A210 having gateways, on-premise servers, or network equipment (nodes A215) located in physically proximate Edge systems; a network access layer A220, encompassing base stations, radio processing units, network hubs, regional data centers (DC), or local network equipment (equipment A225); and any equipment, devices, or nodes located therebetween (in layer A212, not illustrated in detail). The network communications within the Edge cloud A110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer A200, under 5 ms at the Edge devices layer A210, to between 10 to 40 ms when communicating with nodes at the network access layer A220. Beyond the Edge cloud A110 are core network A230 and cloud data center A240 layers, each with increasing latency (e.g., between 50-60 ms at the core network layer A230, to 100 ms or more at the cloud data center layer). As a result, operations at a core network data center A235 or a cloud data center A245, with latencies of at least 50 to 100 ms or more, will not be able to accomplish many time-critical functions of the use cases A205. Each of these latency values is provided for purposes of illustration and contrast. The use of other access network mediums and technologies may further reduce the latencies. In some examples, respective portions of the network may be categorized as “close Edge,” “local Edge,” “near Edge,” “middle Edge,” or “far Edge” layers, relative to a network source and destination. For instance, from the perspective of the core network data center A235 or a cloud data center A245, a central office or content data network may be considered as being located within a “near Edge” layer (“near” to the cloud, having high latency values when communicating with the devices and endpoints of the use cases A205), whereas an access point, base station, on-premise server, or network gateway may be considered as located within a “far Edge” layer (“far” from the cloud, having low latency values when communicating with the devices and endpoints of the use cases A205). It will be understood that other categorizations of a particular network layer as constituting a “close,” “local,” “near,” “middle,” or “far” Edge may be based on latency, distance, number of network hops, or other measurable characteristics, as measured from a source in any of the network layers A200-A240.

The various use cases A205 may access resources under usage pressure from incoming streams, due to multiple services utilizing the Edge cloud. To achieve results with low latency, the services executed within the Edge cloud A110 balance varying requirements in terms of: (a) Priority (throughput or latency) and Quality of Service (QOS) (e.g., traffic for an autonomous car may have higher priority than a temperature sensor in terms of response time requirement; or a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate. In some examples, an SLA is an agreement, commitment and/or contract between entities. The SLA may include parameters (e.g., latency) and corresponding values (e.g., time in milliseconds) that must be satisfied before the SLA is deemed in compliance or not.

Thus, with these variations and service features in mind, Edge computing within the Edge cloud A110 may provide the ability to serve and respond to multiple applications of the use cases A205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because Edge locations may be unmanned and may even need permissioned access (e.g., when housed in a third-party location). Such issues are magnified in the Edge cloud A110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud A110 (network layers A200-A240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco” or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems that include discrete or connected hardware or software configurations to facilitate or use the Edge cloud A110.

As such, the Edge cloud A110 is formed from network components and functional features operated by and within Edge gateway nodes, Edge aggregation nodes, or other Edge compute nodes among network layers A210-A230. The Edge cloud A110 may be embodied as any type of network that provides Edge computing and/or storage resources that are proximately located to radio access network (RAN) capable endpoint devices (e.g., mobile computing devices, IoT devices, smart devices, etc.), which are discussed herein. In other words, the Edge cloud A110 may be envisioned as an “Edge” that connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

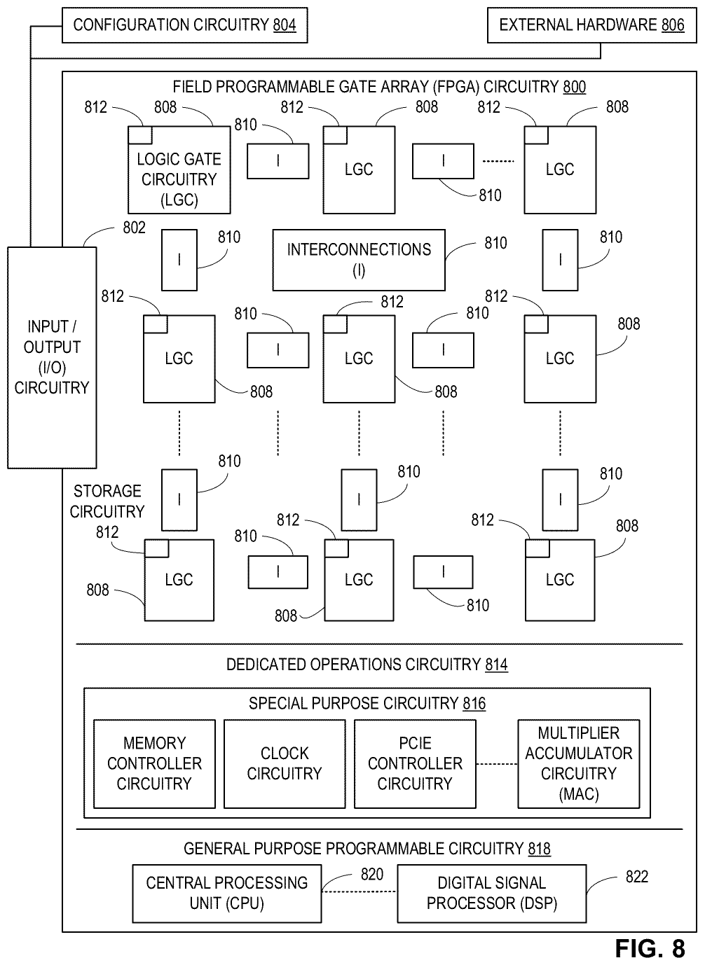

The network components of the Edge cloud A110 may be servers, multi-tenant servers, appliance computing devices, and/or any other type of computing devices. For example, the Edge cloud A110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 8-10, described in further detail below. The Edge cloud A110 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

In FIG. A3, various client endpoints A310 (in the form of mobile devices, computers, autonomous vehicles, business computing equipment, industrial processing equipment) exchange requests and responses that are specific to the type of endpoint network aggregation. For instance, client endpoints A310 may obtain network access via a wired broadband network, by exchanging requests and responses A322 through an on-premise network system A332. Some client endpoints A310, such as mobile computing devices, may obtain network access via a wireless broadband network by exchanging requests and responses A324 through an access point (e.g., cellular network tower) A334. Some client endpoints A310, such as autonomous vehicles, may obtain network access for requests and responses A326 via a wireless vehicular network through a street-located network system A336. However, regardless of the type of network access, the TSP may deploy aggregation points A342, A344 within the Edge cloud A110 to aggregate traffic and requests. Thus, within the Edge cloud A110, the TSP may deploy various compute and storage resources, such as at Edge aggregation nodes A340, to provide requested content. The Edge aggregation nodes A340 and other systems of the Edge cloud A110 are connected to a cloud or data center A360, which uses a backhaul network A350 to fulfill higher-latency requests from a cloud/data center for websites, applications, database servers, etc. Additional or consolidated instances of the Edge aggregation nodes A340 and the aggregation points A342, A344, including those deployed on a single server framework, may also be present within the Edge cloud A110 or other areas of the TSP infrastructure.

FIG. D2 depicts an example of an infrastructure processing unit (IPU). Different examples of IPUs disclosed herein enable improved performance, management, security and coordination functions between entities (e.g., cloud service providers), and enable infrastructure offload and/or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can perform an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes XPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QOS), security, telemetry measurement, event logging, initiating and managing data flows, data placement, or job scheduling of resources on an xPU, storage, memory, or CPU.

In the illustrated example of FIG. D2, the IPU D200 includes or otherwise accesses secure resource managing circuitry D202, network interface controller (NIC) circuitry D204, security and root of trust circuitry D206, resource composition circuitry D208, time stamp managing circuitry D210, memory and storage D212, processing circuitry D214, accelerator circuitry D216, and/or translator circuitry D218. Any number and/or combination of other structure(s) can be used such as but not limited to compression and encryption circuitry D220, memory management and translation unit circuitry D222, compute fabric data switching circuitry D224, security policy enforcing circuitry D226, device virtualizing circuitry D228, telemetry, tracing, logging and monitoring circuitry D230, quality of service circuitry D232, searching circuitry D234, network functioning circuitry (e.g., routing, firewall, load balancing, network address translating (NAT), etc.) D236, reliable transporting, ordering, retransmission, congestion controlling circuitry D238, and high availability, fault handling and migration circuitry D240 shown in FIG. D2. Different examples can use one or more structures (components) of the example IPU D200 together or separately. For example, compression and encryption circuitry D220 can be used as a separate service or chained as part of a data flow with vSwitch and packet encryption.

In some examples, IPU D200 includes a field programmable gate array (FPGA) D270 structured to receive commands from an CPU, XPU, or application via an API and perform commands/tasks on behalf of the CPU, including workload management and offload or accelerator operations. The illustrated example of FIG. D2 may include any number of FPGAs configured and/or otherwise structured to perform any operations of any IPU described herein.

Example compute fabric circuitry D250 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry D260 provides connectivity to a remote smartNIC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing IPU D200, IPU D200 is a root of a system (e.g., rack of servers or data center) and manages compute resources (e.g., CPU, xPU, storage, memory, other IPUs, and so forth) in the IPU D200 and outside of the IPU D200. Different operations of an IPU are described below.

In some examples, the IPU D200 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU D200 is selected to perform a workload, secure resource managing circuitry D202 offloads work to a CPU, xPU, or other device and the IPU D200 accelerates connectivity of distributed runtimes, reduce latency, CPU and increases reliability.

In some examples, secure resource managing circuitry D202 runs a service mesh to decide what resource is to execute workload, and provide for L7 (application layer) and remote procedure call (RPC) traffic to bypass kernel altogether so that a user space application can communicate directly with the example IPU D200 (e.g., IPU D200 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-OF, or CXL.

In some cases, the example IPU D200 dynamically selects itself to run a given workload (e.g., microservice) within a composable infrastructure including an IPU, xPU, CPU, storage, memory, and other devices in a node.

In some examples, communications transit through media interfacing circuitry D260 of the example IPU D200 through a NIC/smartNIC (for cross node communications) or loopback back to a local service on the same host. Communications through the example media interfacing circuitry D260 of the example IPU D200 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU D200 prioritizes its processing to minimize the stalling of the requesting application. In some examples, the IPU D200 schedules the prioritized message request issuing the event to execute a SQL query database and the example IPU constructs microservices that issue SQL queries and the queries are sent to the appropriate devices or services.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using any type of training algorithm. In examples disclosed herein, training may be performed to achieve some degree of convergence. Training is performed using hyperparameters that control how the learning is performed (e.g., a learning rate, a number of layers to be used in the machine learning model, etc.).

Training is performed using training data. In examples disclosed herein, the training data originates from prior results of workload computation on different resources. Because supervised training is used, the training data is labeled. Once training is complete, the model is deployed for use as an executable construct that processes an input and provides an output based on the network of nodes and connections defined in the model. The model is stored at any location, such as within a network node, switch, an IPU, a smart NIC, or network connected storage. The model may then be executed by the example network node and/or switch.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Distributed resources enable task execution without inundating a single monolithic platform by taking advantage of a heterogenous mixture of resource types. However, efficient utilization of such resources is challenging when a degree of complexity in the workload (e.g., payload of information, such as an image to be processed for object identification, facial recognition, etc.) is unknown. For instance, some distributed resources include several processors having multiple cores and relatively large amounts of memory, while other distributed resources include relatively fewer and/or less capable processors. In the event a relatively simple workload (e.g., an image with one or two human faces) is allocated to relatively robust (e.g., high-performance computing (HPC)) resources, then such resources are not efficiently utilized (underutilized) despite being able to satisfy service level agreement (SLA) requirements. On the other hand, in the event a relatively complex workload (e.g., an image with a hundred human faces) is allocated to a relatively lean resource (e.g., an Edge node with a single general purpose processor), then the target resource may not be able to complete the workload in a manner consistent with SLA requirements (e.g., the lean resource may take too much time to complete the workload).

Generally speaking, workloads (also referred to herein as tasks or payloads) have a great deal of diversity in terms of complexity. Such workloads include corresponding compute requirements, latency requirements, bandwidth requirements and/or storage requirements. Similarly, compute resources have a great deal of diversity in terms of processing capabilities (e.g., number of processors, number of cores, number of sockets (e.g., 2 sockets, 16 sockets, etc.), processor specialization (e.g., accelerators, graphical processing units (GPUs), field programmable gate arrays (FPGAs)), available memory (e.g., DRAM, PMEM, etc.) and/or available storage (e.g., hard disks, SSDs, etc.). In some examples, particularly in view of Edge networks/computing, base stations include relatively limited resource capabilities that are situated/located near wireless phone towers, while central offices and data centers (e.g., Google Cloud, Azure, etc.) include relatively more compute resources.

Considering operational variation of incoming workloads, and operational variation of available resources, assigning the workloads becomes a challenge that, if made incorrectly, overestimates allocated resources to the workload or underestimates allocated resources to the workload. For example, in content delivery systems, it may be known a priori that a key value lookup requires fewer compute cycles and relatively low latency access to storage. Thus, hosting a key value database on one or more resources (e.g., servers) improves resource efficiency. Similarly, it may be known a priori that particular high performance computing (HPC) tasks always require matrix operations and/or transforms. Thus, allocating compute and/or bandwidth capable resources is helpful for efficient resource utilization.

However, some circumstances involve workloads and/or associated tasks for which precise computing resource needs are not known a priori. For instance, while a workload type may be known a priori based on accompanying SLA metadata and/or context information (e.g., workload/payload objective information, such as facial recognition), the disparity in workload complexity may be substantial (e.g., hundreds of candidate human faces at a first time of day, relatively fewer candidate human faces at a second time of day, etc.). To satisfy SLA requirements, resources are typically allocated in a manner that implements a liberal guard band. Stated differently, in circumstances where workload complexity is unknown, a robust assortment of resources are allocated and/or otherwise made available for the workload(s) in an effort to comply with SLA requirements.

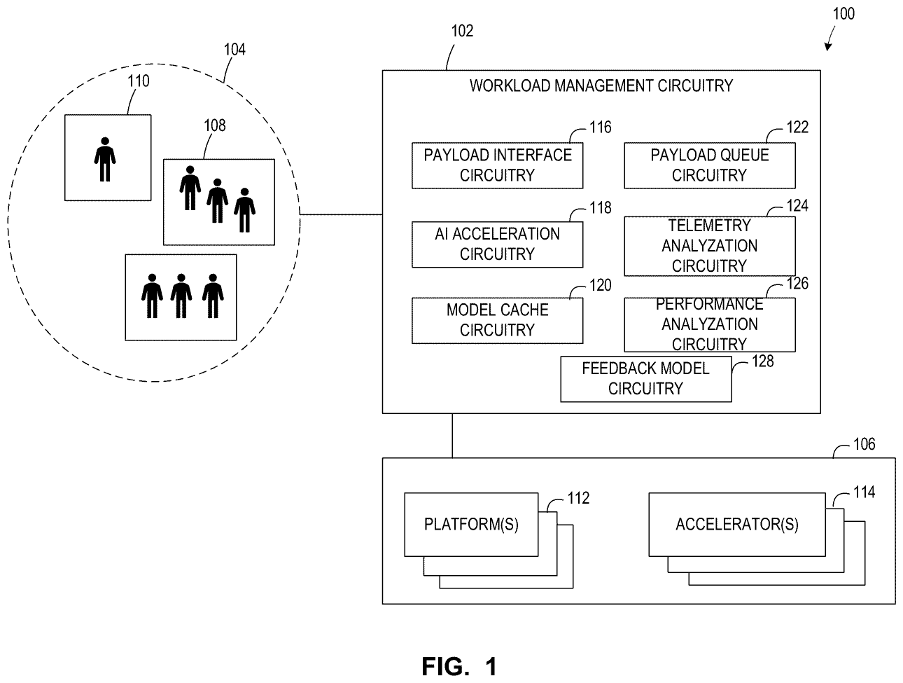

Switching hardware typically routes workload tasks (e.g., payloads) to available resources. Switching hardware includes, but is not limited to, interconnect switching circuitry and protocols such as Compute Express Link™ (CXL™), PCI-e switches, smart NICs, IPU hardware/circuitry, etc. In some examples, switching devices may have limited computation capability such that examples disclosed herein operate based on a cooperative contribution between switching devices and an IPU, a smart NIC and/or other compute resources available on the Edge network. Any combination may be realized by examples disclosed herein, which may vary based on applied and/or available architectures of the Edge network. Examples disclosed herein improve resource utilization efficiency by, in part, including complexity determination at, for instance, the switch level, which is the entity in the best position to route a service request (workloads/payloads) to appropriate resources. Examples disclosed herein expand architectures (e.g., switching architectures) to process service requests to enable, in part, workload problem identification (e.g., person identification, facial recognition, etc.), workload/problem complexity identification/estimation, resource identification to execute the payload(s) in view of resource availability and SLA requirements, and workload queue management. In some examples disclosed herein, an example IPU implements example switching architectures to manage service requests, but examples disclosed herein are not limited thereto. In some examples, switching management of the example workload management circuitry of FIG. 1 is implanted in an example smart NIC. In some examples disclosed herein, payload analysis models generate different combinations of resource requirements for the same resource (e.g., the same accelerator) with different SLA satisfaction criteria. For instance, the switch may determine a candidate resource request delay (e.g., delay by 100 nSec) at the expense of requiring an additional 10% of the resource capability (e.g., an increased operational frequency, increased power demand, etc.).

Examples disclosed herein also include low power artificial intelligence (AI) and/or Markovian based logic feedback techniques and circuitry to select pre-processing models that evaluate payload complexity metrics. In some examples, the AI and/or Markovian based logic feedback techniques generate one or more generic models with workload type information or workload objective information is unavailable.

FIG. 1 illustrates an example workload analysis system 100 constructed in accordance with the teachings of this disclosure. In the illustrated example of FIG. 1, the workload analysis system 100 includes workload management circuitry 102 communicatively connected to ingress workloads 104 and candidate resources 106. As described above, the workloads 104 may include varying degrees of complexity. An example first workload 108 includes an image as the payload having a relatively large number of faces to identify (e.g., high complexity), while an example second workload 110 includes an image as the payload having a relatively small number of faces to identify (e.g., low complexity). However, because neither the first workload 108 nor the second workload 110 has been processed (e.g., resources have not yet been applied to solve a processing objective, such as facial recognition), the example workload management circuitry 102 cannot accurately identify appropriate resources 106 to allocate.

In the illustrated example of FIG. 1, the example resources 106 include any number of example platforms 112 and any number of example accelerators 114. While the example resources 106 illustrate platforms 112 and accelerators 114, additional and/or alternate resources are within the scope of this disclosure, without limitation (e.g., GPUs, convolutional neural network accelerators, etc.). The example workload management circuitry 102 includes example payload interface circuitry 116, example artificial intelligence (AI) acceleration circuitry 118, example model cache circuitry 120, example payload queue circuitry 122, example telemetry analyzation circuitry 124, example performance analyzation circuitry 126 and example feedback modeling circuitry 128. In some non-limiting examples, the workload management circuitry 102 may be implemented as switching circuitry, such as on and/or otherwise within network switch hardware/devices.

In operation, the example workload management circuitry 102 configures one or more pre-processing models based on information related to a problem type (e.g., workload objective information) of an incoming/ingress workload. Problem types (workload objective information) include, for example, facial recognition and object detection, but examples disclosed herein are not limited thereto. Model bitstreams may be stored local to the example switch circuitry 102 and/or may be located externally via a pointer. The example switch circuitry 102 also determines a degree of complexity corresponding to the workload received and/or otherwise retrieved by the workload management circuitry 102. Additionally, information corresponding to an SLA of the workload is used as input to the pre-processing models, which are executed, applied and/or otherwise instantiated to determine and/or otherwise calculate complexity metrics. In some examples, the SLA information includes particular resource requirements to be considered, such as a need for particular specialized processors, particular amounts of memory, etc. As described in further detail below, the example workload management circuitry 102 places any number of workloads into queues to manage resource selections to be applied to the workload(s).

To configure one or more pre-processing models, the example payload interface circuitry 116 determines whether a payload processing request has occurred. If so, it parses and/or otherwise evaluates the payload for workload objective information corresponding to a particular problem of interest that is to be solved by the workload execution. In some examples, the payload information includes metadata indicative of the workload objective, such as image recognition, facial recognition, database searching, etc. Generally speaking, rather than immediately assigning the workload to available resources without regard to a complexity assessment/metric of the workload, examples disclosed herein apply different pre-processing models to evaluate the workload(s) and/or payload information prior to assignment of the workload to available resources. Stated differently, in an effort to utilize available resources in an optimized manner, examples disclosed herein apply some effort to understand the complexity of the workload so that allocation of resources is neither overallocated or under allocated. The example pre-processing models do not process the workload and/or payload information therein to satisfy the SLA objective(s), but rather focus on determining a degree of complexity of such workloads to facilitate optimized resource allocation. Different pre-processing models exhibit particular advantages in determining the degree of complexity with a particular degree of accuracy. For instance, pre-processing models designed for image processing evaluate the workload in a manner consistent with image data structures and/or payload information that is typical for image processing objectives. As such, application of other types of pre-processing models unassociated with image processing may not yield particularly accurate estimates of complexity. Examples disclosed herein select the pre-processing models in a manner to promote improved accuracy in workload complexity determination so that appropriate resources can be selected to process the workload.

The example AI acceleration circuitry 118 selects and/or otherwise registers particular pre-processing models based on available information. As described above, the AI acceleration circuitry 118 selects the model(s) based on model identification information, model type information and applied AI/ML algorithms to reveal particular pre-processing models shown to exhibit threshold accuracy predictions for particular workload types. In some examples, the AI acceleration circuitry 118 accepts inputs from Markovian modeling techniques, particularly in instances where the payload is devoid of information related to a problem or task type of the workload. In such examples, the AI acceleration circuitry 118 generates a generic model (e.g., a generic pre-processing model) when selecting a particular pre-processing model to determine workload complexity. The example model cache circuitry 120 stores selected models and their corresponding bitstreams in cache (e.g., a cache memory of the example workload management circuitry 102). In some examples, the model cache circuitry 120 facilitates storage of the models and/or bitstreams off-device and provides pointers for model retrieval.

To estimate complexity metrics of the workload, the example payload interface circuitry 116 retrieves the pointer to the payload or retrieves the payload from memory. In some examples, the payload interface circuitry 116 selects a storage location (or pointer(s) to storage location(s)) for metadata results when one or more pre-processing models are finished determining a complexity metric. The payload interface circuitry 116 retrieves the SLA information corresponding to the workload/payload and executes the one or more selected pre-processing models in connection with the workload/payload to determine the complexity metric(s). As used herein, a “complexity metric” is a relative score value indicative of an expected hardware demand that the workload will place on target/candidate hardware resources. In some examples, a complexity metric includes a value between zero and one (e.g., 0.79), in which values nearer to one indicate a greater relative computational burden on the allocated resources that are selected to perform workload execution. In some examples, the AI acceleration circuitry 118 invokes the selected pre-processing models to identify, select and/or otherwise activate candidate resources that should be invoked to satisfy the SLA metrics. Such complexity metrics and recommended resources (e.g., a list of resources suggested for use when executing the workload, such as a particular type of processor with a particular number of cores, etc.) are then stored in memory as metadata for later retrieval by the example workload management circuitry 102.

While the example workload management circuitry 102 may receive ingress workloads at any time (and corresponding payload information corresponding to the workloads), such workloads may not necessarily require immediate execution. For example, while an incoming workload is detected and/or otherwise received by the example workload management circuitry 102 at a first time, the corresponding SLA may not require that the task(s) associated with the workload be executed at that first time. Instead, the SLA requirements may dictate that execution can occur at some predetermined time in the future (e.g., milliseconds in the future). Such deferral of immediate execution is particularly beneficial for workload and/or resource balancing and other resource optimization opportunities. The example payload queue circuitry 122 prepares for circumstances where the workload is ready to be executed or otherwise needs to be executed in a manner consistent with SLA requirements by storing the metadata and payload processing request(s) in a switch queue. When the switch queue is invoked, the example telemetry analyzation circuitry 124 evaluates telemetry information corresponding to the resources identified by the metadata and attempts to perform a handshake with those desired resources.

If the example telemetry analyzation circuitry 124 determines that the handshake is not successful, which may be indicative of that particular resource not being available for immediate utilization, the telemetry analyzation circuitry 124 targets one or more alternate resources for the workload. In some examples, the payload interface circuitry 116 generates a ranked list of preferred resources to be utilized with the workload so that alternate resources can be promptly selected in the event of particular resource unavailability that can occur in dynamic Edge network environments where competing network activity consumes resources in a dynamic manner. However, when the handshake is successful, the example workload management circuitry 102 allocates the resources for payload processing and the example performance analyzation circuitry 126 measures performance metrics of those resources while the payload is being processed.

Payload performance metrics include, but are not limited to, binary true/false for SLA requirements, an amount of time the resources consumed to complete the workload, a number of processing cycles consumed to complete the workload, and a quantity of resource utilization during execution of the workload (e.g., 50% utilized, 75% utilized, etc.). In other words, the measured and aggregated payload performance metrics help determine whether the allocated resources are overutilized or underutilized for the workload and also identify whether the previously selected pre-processing models were accurate in determining a degree of complexity of the workload. The example feedback modeling circuitry 128 provides and/or otherwise transmits the payload performance metrics to the example AI acceleration circuitry 118 to improve future model selection(s) when calculating workload complexity. In some examples, the feedback modeling circuitry 128 applies the payload performance metrics to one or more Markovian feedback models to further improve pre-processing model selections when new workloads arrive. Accordingly, pre-processing models selected by examples disclosed herein are also improved with modifications learned by the example AI acceleration circuitry 118.

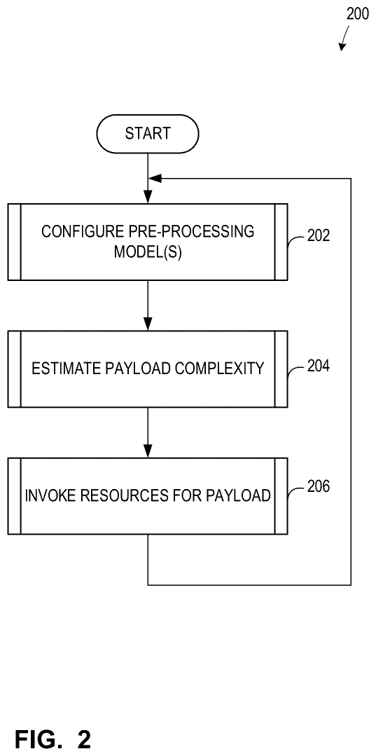

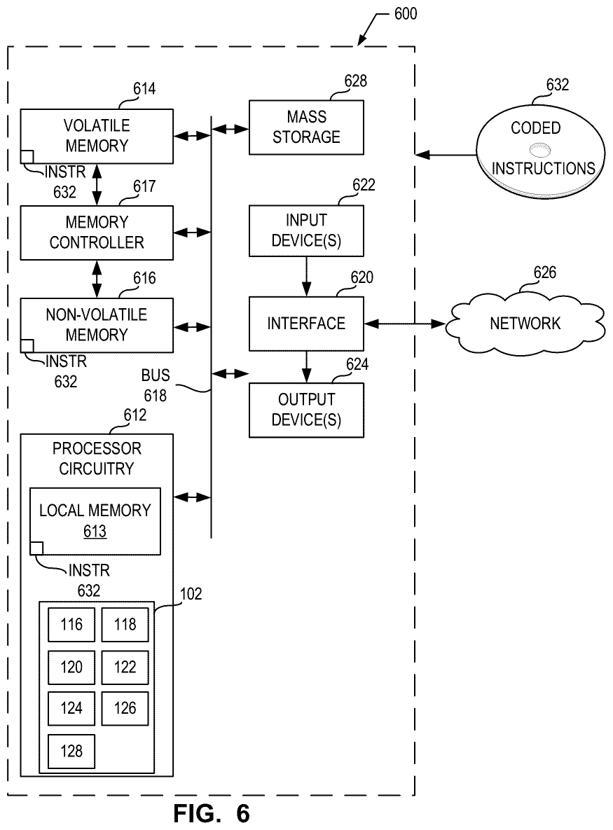

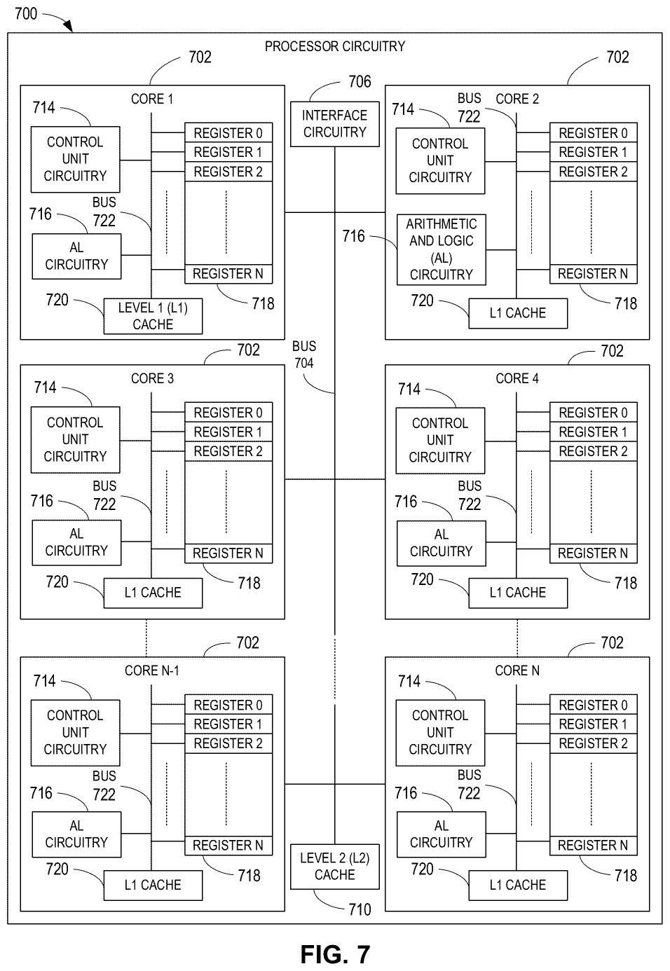

In some examples, the payload interface circuitry 116 includes means for interfacing payloads, the AI acceleration circuitry 118 includes means for accelerating AI, the model cache circuitry 120 includes means for caching models, the payload queue circuitry 122 includes means for queueing payloads, the telemetry analyzation circuitry 124 includes means for analyzing telemetry, the performance analyzation circuitry 126 includes means for analyzing performance, the feedback modeling circuitry 128 includes means for modeling feedback, and the workload management circuitry 102 includes means for switching. For example, the means for interfacing payloads may be implemented by the example payload interface circuitry 116, the means for accelerating AI may be implemented by example AI acceleration circuitry 118, the means for caching models may be implemented by example model cache circuitry 120, the means for queueing payloads may be implemented by example payload queue circuitry 122, the means for analyzing telemetry may be implemented by example telemetry analyzation circuitry 124, the means for analyzing performance may be implemented by example performance analyzation circuitry 126, the means for modeling feedback may be implemented by example feedback modeling circuitry 128, and the means for switching may be implemented by example workload management circuitry 102. In some examples, the aforementioned circuitry may be instantiated by processor circuitry such as the example processor circuitry 612 of FIG. 6. For instance, the aforementioned circuitry of FIG. 1 may be instantiated by the example general purpose processor circuitry 600 of FIG. 6 executing machine executable instructions such as that implemented by at least blocks of FIGS. 2-5. In some examples, the aforementioned circuitry of FIG. 1 may be instantiated by hardware logic circuitry, which may be implemented by an ASIC or the FPGA circuitry 700 of FIG. 7 structured to perform operations corresponding to the machine readable instructions. Additionally or alternatively, the aforementioned circuitry of FIG. 1 may be instantiated by any other combination of hardware, software, and/or firmware. For example, the aforementioned circuitry of FIG. 1 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example workload management circuitry 102 of FIG. 1 is illustrated in FIG. 1, one or more of the elements, processes, and/or devices illustrated in FIG. 1 may be combined, divided, re-arranged, omitted, eliminated, and/or implemented in any other way. Further, the example payload interface circuitry 116, the example AI acceleration circuitry 118, the example model cache circuitry 120, the example payload queue circuitry 122, the example telemetry analyzation circuitry 124, the example performance analyzation circuitry 126, the example feedback modeling circuitry 128 and/or, more generally, the example workload management circuitry 102 of FIG. 1, may be implemented by hardware alone or by hardware in combination with software and/or firmware. Thus, for example, any of the example payload interface circuitry 116, the example AI acceleration circuitry 118, the example model cache circuitry 120, the example payload queue circuitry 122, the example telemetry analyzation circuitry 124, the example performance analyzation circuitry 126, the example feedback modeling circuitry 128 and/or, more generally, the example workload management circuitry 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example workload management circuitry 102 of FIG. 1 may include one or more elements, processes, and/or devices in addition to, or instead of, those illustrated in FIGS. 2-5, and/or may include more than one of any or all of the illustrated elements, processes and devices.

Flowcharts representative of example hardware logic circuitry, machine readable instructions, hardware implemented state machines, and/or any combination thereof for implementing the example workload management circuitry 102 of FIG. 1 are shown in FIGS. 2-5. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 2-5, many other methods of implementing the example workload management circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2-5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 2 is a flowchart representative of example machine readable instructions and/or example operations 200 that may be executed and/or instantiated by processor circuitry to estimate workload complexity. In the illustrated example of FIG. 2, the example workload management circuitry 102 configures one or more pre-processing models (block 202) based on information related to a problem type of an incoming/ingress workload. As described above, problem types include, for example, facial recognition and object detection, but examples disclosed herein are not limited thereto. Based on the one or more selected and/or otherwise configured pre-processing models, the example workload management circuitry 102 estimates payload complexity (block 204) as described above and in further detail below. Depending on the complexity of the payload (e.g., one or more payloads corresponding to a workload to be executed by available resources), the example workload management circuitry 102 invokes appropriate resources to accomplish tasks associated with the workload (block 206), as described above and in further detail below.

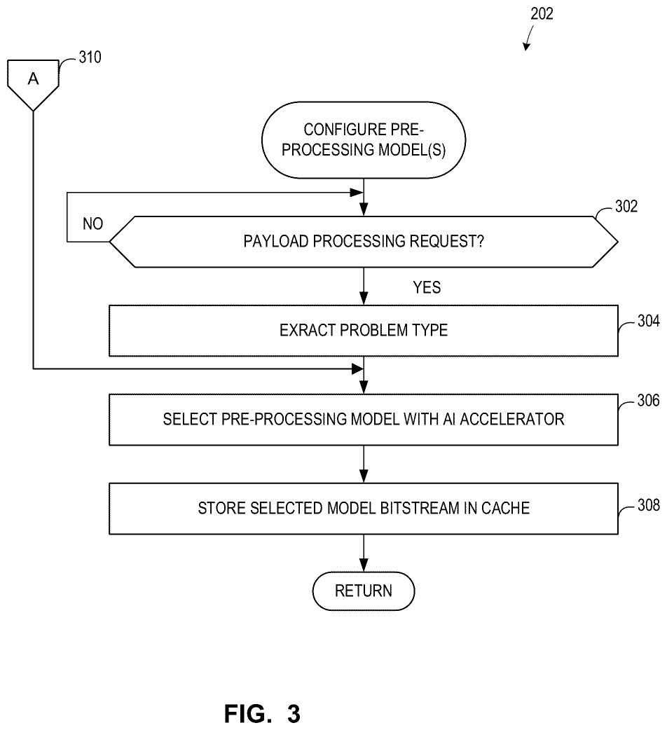

FIG. 3 illustrates additional detail corresponding to configuring pre-process models (block 202) of FIG. 2. In the illustrated example of FIG. 3, the example payload interface circuitry 116 determines if there is any payload processing request (block 302). For example, the workload management circuitry 102 may be located as a structural part of a smart NIC that receives, retrieves and/or otherwise obtains communications via one or more networks, in which some communications correspond to a workload request (e.g., having payload information). In response to detecting a request (block 302), the example payload interface circuitry 116 extracts (e.g., parses, retrieves, detects, identifies, obtains, etc.) problem type information and/or workload objective information from the workload (block 304), such as metadata indicative of the type of problem that the workload is responsible for solving. In some examples, the payload interface circuitry 116 extracts by parsing SLA criteria corresponding to the workload. The example AI acceleration circuitry 118 selects and/or otherwise registers pre-processing models that are candidates for use in determining complexity metrics of the workload (block 306). Any number and/or type of pre-processing models may be available to the example workload management circuitry 102, such as models stored in a memory of the workload management circuitry 102 and/or any network accessible storage and/or cache. The AI acceleration circuitry 118 applies one or more AI/ML algorithms in an effort to select a pre-processing model that is best suited for the workload in question. The example AI acceleration circuitry 118 utilizes any number of inputs to make a pre-processing model selection, including information corresponding to workload objective information (e.g., image processing) and feedback information corresponding to one or more prior instances of workload execution. In some examples, the AI acceleration circuitry 118 retrieves and/or otherwise receives feedback corresponding to any number of prior workload execution iterations. Each candidate model includes a model identifier and a model type. Additionally, models may include corresponding bit streams or executables for implementation or instantiation by the example AI acceleration circuitry 118. The example model cache circuitry 120 stores one or more selected models (e.g., models selected by one or more AI/ML algorithms executed by the example AI acceleration circuitry 118 to identify relative best choices of candidate pre-processing models) and/or corresponding model bit streams in cache memory (block 308). In some examples, the AI acceleration circuitry 118 receives, retrieves and/or otherwise obtains feedback corresponding to one or more prior workload execution instances (input 310). Such information corresponding to prior workload execution instances (input 310) may include SLA performance metrics, workload time-of-day information, prior complexity metric information, prior resource recommendation information (e.g., dual core processor recommendation information, GPU recommendation, etc.). Control then returns to block 204 of FIG. 2.

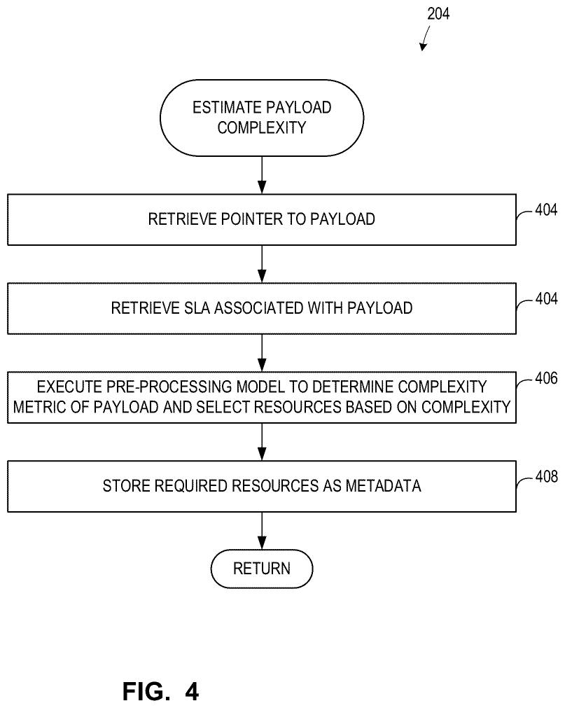

FIG. 4 illustrates additional detail corresponding to estimating payload complexity (block 204) of FIG. 2. In the illustrated example of FIG. 4, the example payload interface circuitry 116 retrieves the pointer to the payload or retrieves the payload from memory (block 402). The payload interface circuitry 116 retrieves the SLA information corresponding to the workload/payload (block 404), and the example AI acceleration circuitry 118 executes the one or more selected pre-processing models in connection with the workload/payload to determine the complexity metric(s) (block 406). In some examples, the pre-processing models also identify, invoke, initiate and/or otherwise activate (e.g., based on the complexity metric(s)) candidate resources suitable for the corresponding complexity of the analyzed workload. Such complexity metrics and recommended resources (e.g., a list of resources suggested for use when executing the workload, such as a particular type of processor with a particular number of cores, etc.) are then stored in memory as metadata (block 408) for later retrieval by the example workload management circuitry 102. Control then returns to block 206 of FIG. 2.

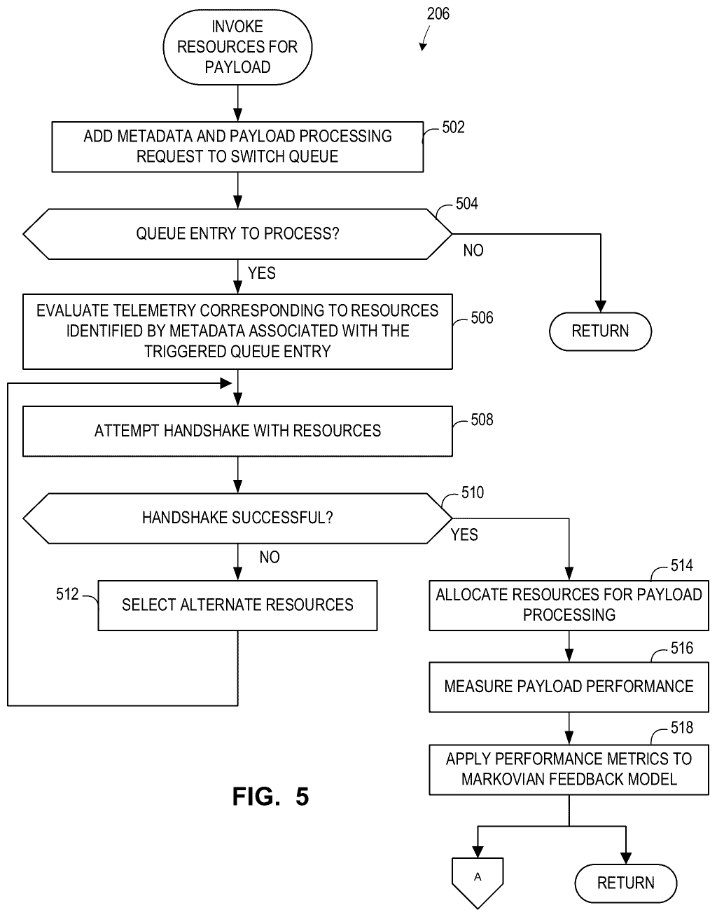

FIG. 5 illustrates additional detail corresponding to invoking resources corresponding to the workload/payload (block 206) of FIG. 2. In the illustrated example of FIG. 5, the example payload queue circuitry 122 prepares for circumstances where the workload is ready to be executed or otherwise needs to be executed in a manner consistent with SLA requirements by storing the metadata and payload processing request(s) in a switch queue (block 502). The payload queue circuitry 122 causes an execution trigger based on, in part, SLA criteria (e.g., execute workload every 500 milliseconds). The example telemetry analyzation circuitry 124 monitors for the occurrence of a queue entry being invoked (block 504). If not, the example process 206 either continues to monitor for such an occurrence or returns. When the switch queue is invoked, the example telemetry analyzation circuitry 124 invokes a handshake to evaluate telemetry information corresponding to the resources identified by the metadata (block 506) and attempts to perform a handshake with those desired resources (block 508).

If the example telemetry analyzation circuitry 124 determines that the handshake is not successful (block 510) with first selected resources, which, as described above, may be indicative of that particular resource not being available for immediate utilization, the telemetry analyzation circuitry 124 targets one or more alternate (e.g., second) resources for the workload (block 512). Control then returns to block 508. On the other hand, when the handshake is successful (block 510), the example workload management circuitry 102 allocates the resources for payload processing (block 514) and the example performance analyzation circuitry 126 measures performance metrics of those resources while the payload is being processed (block 516). The example feedback modeling circuitry 128 provides and/or otherwise transmits the payload performance metrics to the example AI acceleration circuitry 118 to improve future model selection(s) when calculating workload complexity (block 518). As described above, in some examples the feedback modeling circuitry 128 applies the payload performance metrics to one or more Markovian feedback models to further improve pre-processing model selections when new workloads arrive (block 518).

FIG. 6 is a block diagram of an example processor platform 600 structured to execute and/or instantiate the machine readable instructions and/or the operations of FIGS. 2-5 to implement the workload management circuitry 102 of FIG. 1. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a set top box, a headset (e.g., an augmented reality (AR) headset, a virtual reality (VR) headset, etc.) or other wearable device, a network interface card (NIC) (e.g., a smart NIC) or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs, microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the example payload interface circuitry 116, the example AI acceleration circuitry 118, the example model cache circuitry 120, the example payload queue circuitry 122, the example telemetry analyzation circuitry 124, the example performance analyzation circuitry 126, the example feedback modeling circuitry 128 and/or, more generally, the example workload management circuitry 102 of FIG. 1.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 632, which may be implemented by the machine readable instructions of FIGS. 2-5, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a general purpose microprocessor 700. The general purpose microprocessor circuitry 700 executes some or all of the machine readable instructions of the flowcharts of FIGS. 2-5 to effectively instantiate the circuitry of FIG. 1 as logic circuits to perform the operations corresponding to those machine readable instructions. In some such examples, the circuitry of FIG. 1 is instantiated by the hardware circuits of the microprocessor in combination with the instructions. For example, the microprocessor 700 may implement multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 2-5.

The cores 702 may communicate by a first example bus 704. In some examples, the first bus 704 may implement a communication bus to effectuate communication associated with one(s) of the cores 702. For example, the first bus 704 may implement at least one of an Inter-Integrated Circuit (I2C) bus, a Serial Peripheral Interface (SPI) bus, a PCI bus, or a PCIe bus. Additionally or alternatively, the first bus 704 may implement any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2_cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the L1 cache 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may implement at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 8 is a block diagram of another example implementation of the processor circuitry 612 of FIG. 6. In this example, the processor circuitry 612 is implemented by FPGA circuitry 800. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowcharts of FIGS. 2-5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowcharts of FIGS. 2-5. In particular, the FPGA 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowcharts of FIGS. 2-5. As such, the FPGA circuitry 800 may be structured to effectively instantiate some or all of the machine readable instructions of the flowcharts of FIGS. 2-5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 2-5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware (e.g., external hardware circuitry) 806. For example, the configuration circuitry 804 may implement interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor 700 of FIG. 7. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIGS. 2-5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowcharts of FIGS. 2-5 may be executed by one or more of the cores 702 of FIG. 7, a second portion of the machine readable instructions represented by the flowcharts of FIGS. 2-5 may be executed by the FPGA circuitry 800 of FIG. 8, and/or a third portion of the machine readable instructions represented by the flowcharts of FIGS. 2-5 may be executed by an ASIC. It should be understood that some or all of the circuitry of FIG. 1 may, thus, be instantiated at the same or different times. Some or all of the circuitry may be instantiated, for example, in one or more threads executing concurrently and/or in series. Moreover, in some examples, some or all of the circuitry of FIG. 1 may be implemented within one or more virtual machines and/or containers executing on the microprocessor.

In some examples, the processor circuitry 612 of FIG. 6 may be in one or more packages. For example, the processor circuitry 700 of FIG. 7 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

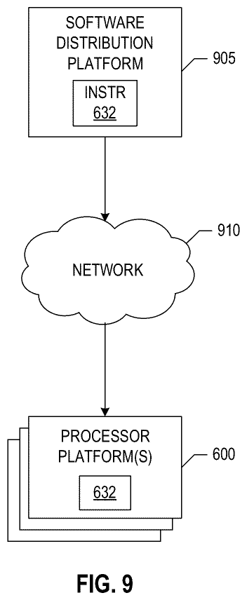

A block diagram illustrating an example software distribution platform 905 to distribute software such as the example machine readable instructions 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 2-5, as described above. The one or more servers of the example software distribution platform 905 are in communication with a network 910, which may correspond to any one or more of the Internet and/or any of the example networks described herein. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 2-5, may be downloaded to the example processor platform 600, which is to execute the machine readable instructions 632 to implement examples disclosed herein. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices.

From the foregoing, it will be appreciated that example systems, methods, apparatus, and articles of manufacture have been disclosed that facilitate utilization of resources in a manner that decreases instances of over estimation (e.g., allocating too many resources for a given workload) and under estimation (e.g., allocating too few resources for a given workload). Unlike traditional network switching architecture that applies general heuristics when deciding which resources to route a workload, examples disclosed herein apply one or more pre-processing models to the workload (e.g., a payload of data, such as a bitmap, an image, etc.) to determine a complexity metric corresponding to the workload prior to resource allocation. Additionally, such decision logic may be located in the network switch in an effort to facilitate resource allocation in a prompt manner.

Example methods, systems, articles of manufacture and apparatus to estimate workload complexity are disclosed herein. Further examples and combinations thereof include the following:

Example 1 includes an apparatus to select workload resources, the apparatus comprising interface circuitry to communicate with an edge device, and processor circuitry including one or more of at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations, or the third operations to instantiate payload interface circuitry to extract workload objective information and service level agreement (SLA) criteria corresponding to a workload, and acceleration circuitry to select a pre-processing model based on (a) the workload objective information and (b) feedback corresponding to workload performance metrics of at least one prior workload execution iteration, execute the pre-processing model to calculate a complexity metric corresponding to the workload, and select candidate resources based on the complexity metric.

Example 2 includes the apparatus as defined in example 1, wherein the processor circuitry is to perform at least one of the first operations, the second operations, or the third operations to instantiate the payload interface circuitry to identify the extracted workload information as at least one of image processing, facial identification or object detection.

Example 3 includes the apparatus as defined in example 1, wherein the processor circuitry is to perform at least one of the first operations, the second operations, or the third operations to instantiate the acceleration circuitry to apply a Markovian model to generate the feedback corresponding to the workload performance metrics.

Example 4 includes the apparatus as defined in example 1, wherein the processor circuitry is to perform at least one of the first operations, the second operations, or the third operations to instantiate payload queue circuitry to add a request for execution of the workload to a switch queue.

Example 5 includes the apparatus as defined in example 4, wherein the payload queue circuitry is to cause an execution trigger based on the SLA criteria.

Example 6 includes the apparatus as defined in example 5, wherein the processor circuitry is to perform at least one of the first operations, the second operations, or the third operations to instantiate telemetry analyzation circuitry to invoke a handshake with first resources in response to the execution trigger.

Example 7 includes the apparatus as defined in example 6, wherein the telemetry analyzation circuitry is to invoke second resources when the handshake with the first resources is unsuccessful.

Example 8 includes the apparatus as defined in example 1, wherein at least one of the first operations, the second operations, or the third operations are instantiated on at least one of a switching device, a smart network interface card, or an infrastructure processing unit.

Example 9 includes at least one non-transitory computer readable medium comprising instructions that, when executed, cause processor circuitry to at least parse workload objective information and service level agreement (SLA) criteria corresponding to a workload, select a pre-processing model based on (a) the workload objective information and (b) feedback corresponding to workload performance metrics of at least one prior workload execution iteration, instantiate the pre-processing model to calculate a complexity metric corresponding to the workload, and invoke candidate resources based on the complexity metric.

Example 10 includes the at least one non-transitory computer readable medium as defined in example 9, wherein the instructions, when executed, cause the processor circuitry to identify the extracted workload information as at least one of image processing, facial identification or object detection.

Example 11 includes the at least one non-transitory computer readable medium as defined in example 9, wherein the instructions, when executed, cause the processor circuitry to apply a Markovian model to generate the feedback corresponding to the workload performance metrics.

Example 12 includes the at least one non-transitory computer readable medium as defined in example 9, wherein the instructions, when executed, cause the processor circuitry to add a request for execution of the workload to a switch queue.

Example 13 includes the at least one non-transitory computer readable medium as defined in example 12, wherein the instructions, when executed, cause the processor circuitry to cause an execution trigger based on the SLA criteria.

Example 14 includes the at least one non-transitory computer readable medium as defined in example 13, wherein the instructions, when executed, cause the processor circuitry to invoke a handshake with first resources in response to the execution trigger.

Example 15 includes the at least one non-transitory computer readable medium as defined in example 14, wherein the instructions, when executed, cause the processor circuitry to invoke second resources when the handshake with the first resources is unsuccessful.

Example 16 includes an apparatus to invoke workload resources, the apparatus comprising means for interfacing payloads to extract workload objective information and service level agreement (SLA) criteria corresponding to a workload, and means for accelerating to select a pre-processing model based on (a) the workload objective information and (b) feedback corresponding to workload performance metrics of at least one prior workload execution iteration, execute the pre-processing model to calculate a complexity metric corresponding to the workload, and select candidate resources based on the complexity metric.

Example 17 includes the apparatus as defined in example 16, wherein the means for interfacing is to identify the extracted workload information as at least one of image processing, facial identification or object detection.

Example 18 includes the apparatus as defined in example 16, wherein the means for accelerating is to execute a Markovian model to generate the feedback corresponding to the workload performance metrics.

Example 19 includes the apparatus as defined in example 16, further including means for queueing payloads to add a request for execution of the workload to a switch queue.

Example 20 includes the apparatus as defined in example 18, wherein the means for queueing is to cause an execution trigger based on the SLA criteria.

Example 21 includes the apparatus as defined in example 20, further including means for analyzing to invoke a handshake with first resources in response to the execution trigger.

Example 22 includes the apparatus as defined in example 21, wherein the means for analyzing is to invoke second resources when the handshake with the first resources is unsuccessful.

Example 23 includes the apparatus as defined in example 16, wherein the apparatus to invoke workload resources includes at least one of a network switch, a smart network interface card, or an infrastructure processing unit.

Example 24 includes a method comprising parsing, by executing an instruction with processor circuitry, workload objective information and service level agreement (SLA) criteria corresponding to a workload, selecting, by executing an instruction with the processor circuitry, a pre-processing model based on (a) the workload objective information and (b) feedback corresponding to workload performance metrics of at least one prior workload execution iteration, instantiating, by executing an instruction with the processor circuitry, the pre-processing model to calculate a complexity metric corresponding to the workload, and invoking, by executing an instruction with the processor circuitry, candidate resources based on the complexity metric.

Example 25 includes the method as defined in example 22, further including identifying the extracted workload information as at least one of image processing, facial identification or object detection.

Example 26 includes the method as defined in example 24, further including invoking a Markovian model to generate the feedback corresponding to the workload performance metrics.

Example 27 includes the method as defined in example 24, further including adding a request for execution of the workload to a switch queue.

Example 28 includes the method as defined in example 27, further including causing an execution trigger based on the SLA criteria.

Example 29 includes the method as defined in example 28, further including initiating a handshake with first resources in response to the execution trigger.

Example 30 includes the method as defined in example 29, further including invoking resources when the handshake with the first resources is unsuccessful.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to select workload resources, the apparatus comprising:
interface circuitry to communicate with an edge device; and
processor circuitry including one or more of:
at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations;
the processor circuitry to perform at least one of the first operations, the second operations, or the third operations to instantiate:
payload interface circuitry to extract workload objective information and service level agreement (SLA) criteria corresponding to a workload; and
acceleration circuitry to:
select a pre-processing model based on (a) the workload objective information and (b) feedback corresponding to workload performance metrics of at least one prior workload execution iteration;
execute the pre-processing model to calculate a complexity metric corresponding to the workload; and
select candidate resources based on the complexity metric.

2. The apparatus as defined in claim 1, wherein the processor circuitry is to perform at least one of the first operations, the second operations, or the third operations to instantiate the payload interface circuitry to identify the extracted workload information as at least one of image processing, facial identification or object detection.

3. The apparatus as defined in claim 1, wherein the processor circuitry is to perform at least one of the first operations, the second operations, or the third operations to instantiate the acceleration circuitry to apply a Markovian model to generate the feedback corresponding to the workload performance metrics.

4. The apparatus as defined in claim 1, wherein the processor circuitry is to perform at least one of the first operations, the second operations, or the third operations to instantiate payload queue circuitry to add a request for execution of the workload to a switch queue.

5. The apparatus as defined in claim 4, wherein the payload queue circuitry is to cause an execution trigger based on the SLA criteria.

6. The apparatus as defined in claim 5, wherein the processor circuitry is to perform at least one of the first operations, the second operations, or the third operations to instantiate telemetry analyzation circuitry to invoke a handshake with first resources in response to the execution trigger.

7. The apparatus as defined in claim 6, wherein the telemetry analyzation circuitry is to invoke second resources when the handshake with the first resources is unsuccessful.

8. The apparatus as defined in claim 1, wherein at least one of the first operations, the second operations, or the third operations are instantiated on at least one of a switching device, a smart network interface card, or an infrastructure processing unit.

9. At least one non-transitory computer readable medium comprising instructions that, when executed, cause processor circuitry to at least:
parse workload objective information and service level agreement (SLA) criteria corresponding to a workload;
select a pre-processing model based on (a) the workload objective information and (b) feedback corresponding to workload performance metrics of at least one prior workload execution iteration;
instantiate the pre-processing model to calculate a complexity metric corresponding to the workload; and
invoke candidate resources based on the complexity metric.

10. The at least one non-transitory computer readable medium as defined in claim 9, wherein the instructions, when executed, cause the processor circuitry to identify the extracted workload information as at least one of image processing, facial identification or object detection.

11. The at least one non-transitory computer readable medium as defined in claim 9, wherein the instructions, when executed, cause the processor circuitry to apply a Markovian model to generate the feedback corresponding to the workload performance metrics.

12. The at least one non-transitory computer readable medium as defined in claim 9, wherein the instructions, when executed, cause the processor circuitry to add a request for execution of the workload to a switch queue.

13. The at least one non-transitory computer readable medium as defined in claim 12, wherein the instructions, when executed, cause the processor circuitry to cause an execution trigger based on the SLA criteria.

14. The at least one non-transitory computer readable medium as defined in claim 13, wherein the instructions, when executed, cause the processor circuitry to invoke a handshake with first resources in response to the execution trigger.

15. The at least one non-transitory computer readable medium as defined in claim 14, wherein the instructions, when executed, cause the processor circuitry to invoke second resources when the handshake with the first resources is unsuccessful.

16. An apparatus to invoke workload resources, the apparatus comprising:
means for interfacing payloads to extract workload objective information and service level agreement (SLA) criteria corresponding to a workload; and
means for accelerating to:
select a pre-processing model based on (a) the workload objective information and (b) feedback corresponding to workload performance metrics of at least one prior workload execution iteration;
execute the pre-processing model to calculate a complexity metric corresponding to the workload; and
select candidate resources based on the complexity metric.

17. The apparatus as defined in claim 16, wherein the means for interfacing is to identify the extracted workload information as at least one of image processing, facial identification or object detection.

18. The apparatus as defined in claim 16, wherein the means for accelerating is to execute a Markovian model to generate the feedback corresponding to the workload performance metrics.

19. The apparatus as defined in claim 16, further including means for queueing payloads to add a request for execution of the workload to a switch queue.

20. The apparatus as defined in claim 19, wherein the means for queueing is to cause an execution trigger based on the SLA criteria.

21-30. (canceled)
